(19) United States
(12) Patent Application Publication
(10) Pub. No.: US 2015/0286232 A1
(43) Pub. Date: Oct. 8, 2015

(54) VOLTAGE REGULATION CIRCUIT

(71) Applicant: FUJITSU LIMITED, Kawasaki-shi (JP)

(72) Inventor: Samir PARIKH, San Jose, CA (US)

(73) Assignee: FUJITSU LIMITED, Kawasaki-shi (JP)

(21) Appl. No.: 14/248,175

(22) Filed: Apr. 8, 2014

(51) Int. Cl. G05F 1/56; G06F 17/50

(52) U.S. Cl. CPC G05F 1/56; G06F 17/5045

(57) ABSTRACT

A circuit may include a low-dropout (LDO) voltage regulator. The LDO voltage regulator may include an output coupled to a supply of a load circuit. The LDO voltage regulator may be configured to provide a supply voltage to the load circuit. The circuit may also include a current source coupled to the supply of the load circuit and the output of the LDO voltage regulator. The current source may be configured to supply current to the load circuit in a manner that reduces current supplied to the load circuit by the LDO voltage regulator.

### FIELD

The embodiments discussed herein are related to voltage regulation circuits.

### BACKGROUND

Many electrical circuits have specific voltage and current specifications and may be driven as load circuits by another circuit configured to provide the specific voltage and current requirements. Often a low-dropout (LDO) voltage regulator is used to drive load circuits. The current and/or voltage requirements of the load circuit may dictate the size of one or more components of the LDO voltage regulator, which may in turn dictate the inclusion of other components and configurations that may allow for a desired interaction between the load circuit and the LDO voltage regulator.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a circuit may include a low-dropout (LDO) voltage regulator. The LDO voltage regulator may include an output coupled to a supply of a load circuit. The LDO voltage regulator may be configured to provide a supply voltage to the load circuit. The circuit may also include a current source coupled to the supply of the load circuit and the output of the LDO voltage regulator. The current source may be configured to supply current to the load circuit in a manner that reduces current supplied to the load circuit by the LDO voltage regulator.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example voltage regulation circuit;

FIG. 2 illustrates another example voltage regulation circuit;

FIG. 3 illustrates another example voltage regulation circuit; and

FIG. 4 is a flowchart of an example method of designing a voltage regulation circuit.

### DESCRIPTION OF EMBODIMENTS

According to an aspect of an embodiment, a voltage regulation circuit is disclosed that may include voltage regulator, such as a low-dropout (LDO) voltage regulator and a current source. The voltage regulation circuit may be configured to provide a supply voltage to a load circuit based on a voltage requirement of the load circuit. The load circuit may also draw a certain amount of current, which may be referred to as a load current. The voltage regulator and the current source may each provide a portion of the load current to the load circuit.

Embodiments of the present disclosure will be explained with reference to the accompanying drawings.

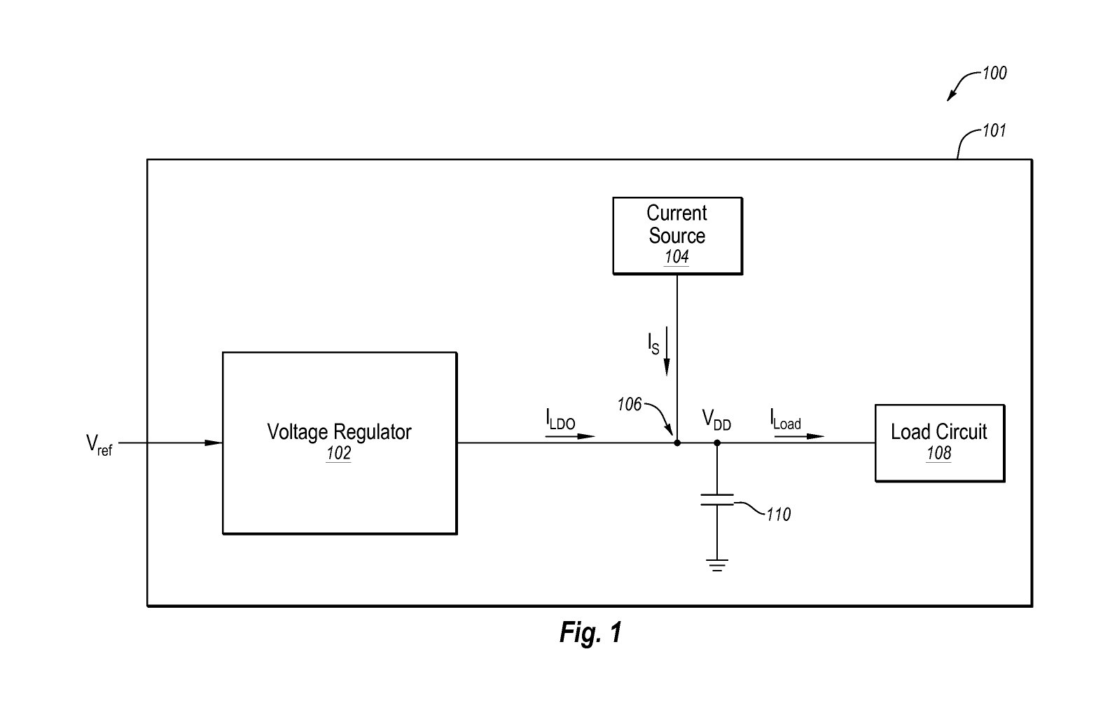

FIG. 1 illustrates an example voltage regulation circuit 100 (“the circuit 100”), arranged in accordance with at least one embodiment described herein. In some embodiments, the circuit 100 may be a chip that is manufactured as a single encapsulated silicon die. In other embodiments, one or more components of the circuit 100 may be included on different chips associated with separate encapsulated silicon dies. The circuit 100 may include a voltage regulator 102 (referred to hereinafter as “the regulator 102”), a current source 104, a load circuit 108, and a capacitor 110. In the illustrated embodiment, the regulator 102, the current source 104, the load circuit 108, and the capacitor 110 are depicted as being included on an encapsulated silicon die 101, as an example.

The load circuit 108 may be any suitable circuit that may have a specific voltage requirement. The load circuit 108 may also draw a certain amount of current during its operations. The current drawn by the load circuit 108 is illustrated as “I_{Load}” in FIG. 1. By way of example and not limitation, the load circuit 108 may include any number of active and/or passive electrical components such as transistors, resistors, capacitors, inductors, inverters, amplifiers, logic gates, etc. The load circuit 108 may have its supply coupled to a supply node 106 of the circuit 100 such that the load circuit 108 may receive its power from the supply node 106.

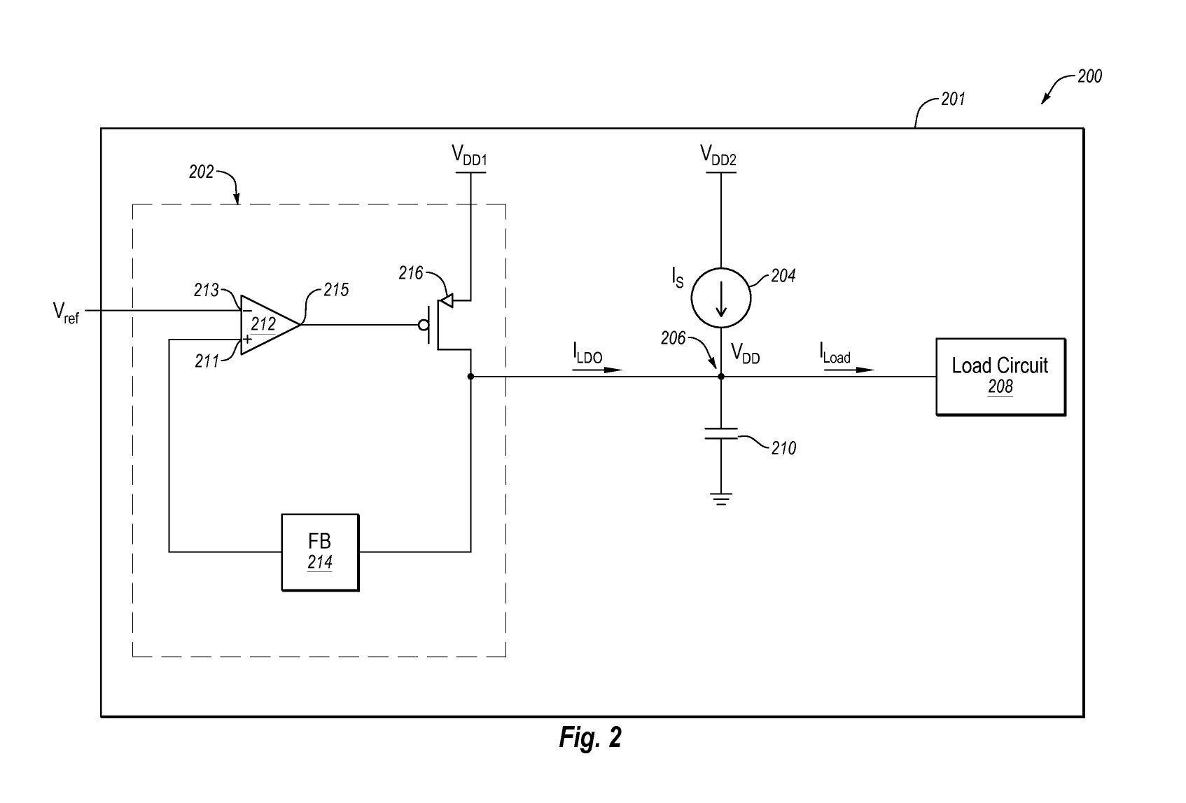

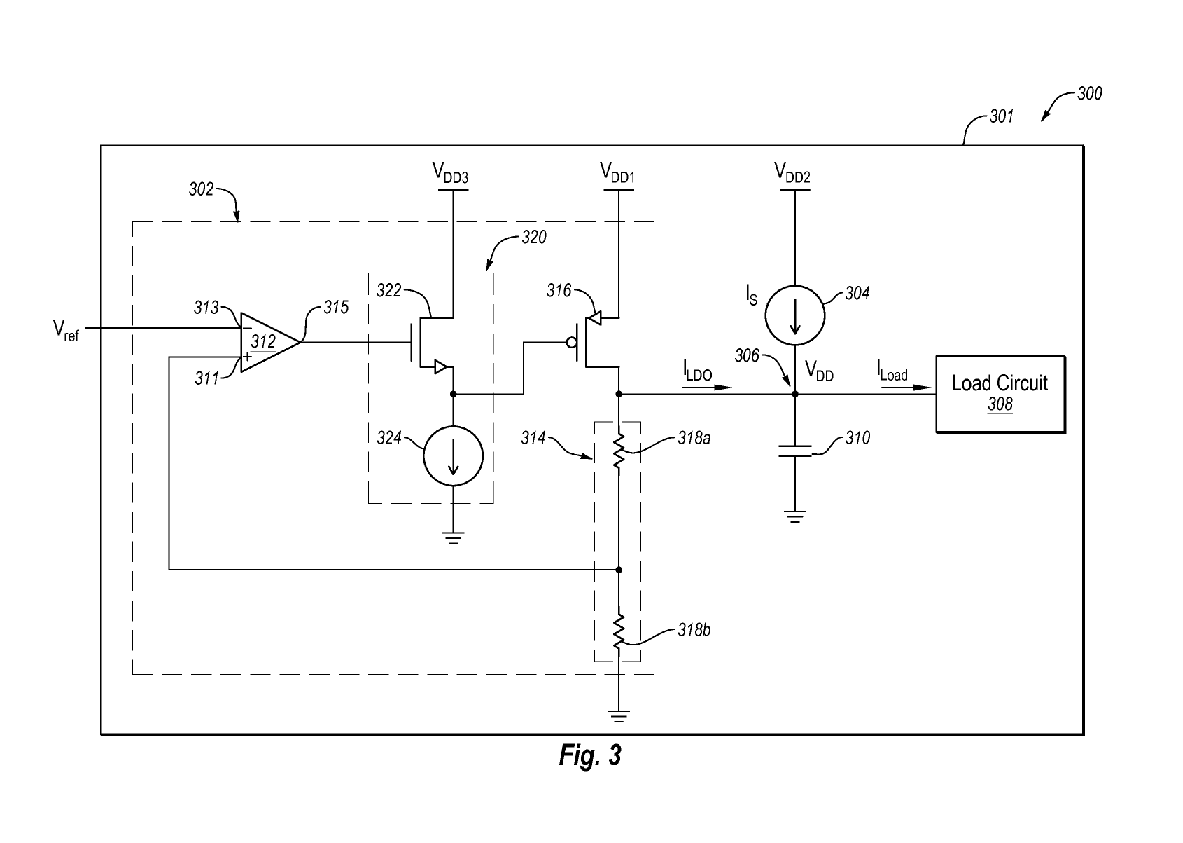

The regulator 102 may be any suitable LDO voltage regulator configured to generate, as an output, a supply voltage V_{DD} based off of a reference voltage V_{Ref} that may be received by the regulator 102 as an input. FIGS. 2 and 3, described in detail below, illustrate example configurations of voltage regulation circuits that each include an LDO voltage regulator that may be used as the regulator 102. In the illustrated embodiment, the regulator 102 may be configured to generate the supply voltage V_{DD} based on the voltage requirements of the load circuit 108. Therefore, the output of the regulator 102 may be coupled to the supply node 106 such that the regulator 102 may provide the supply voltage V_{DD} to the load circuit 108. In some embodiments, the regulator 102 and the load circuit 108 may be included on the same encapsulated silicon die (e.g., chip) or may be included on separate encapsulated silicon dies.

The circuit 100 may also include a current source 104 coupled to the supply node 106. The current source 104 may include any suitable arrangement of electrical components configured to act as a current source. The current source 104 may be configured to generate a low frequency (e.g., a DC current or a current less than 10 Hz) source current Iₛ that may be supplied to the load circuit 108 via the supply node 106. Therefore, the source current Iₛ may provide at least a portion of the load current L_{Load} to the load circuit 108. For example, in some embodiments, the source current Iₛ may provide most or all of the low frequency components (e.g., components less than 10 Hz) of the load current I_{Load}. In some embodiments, the current source 104 may be included on the same encapsulated silicon die as the regulator 102. In other embodiments, the current source 104 and the regulator 102 may be included on separate encapsulated silicon dies.

The regulator 102 may also be configured to supply an LDO current I_{LDO} to the load circuit 108 such that at least a portion of the load current I_{Load} may include the LDO current I_{LDO}. The LDO current I_{LDO} may provide the portions of the load current I_{Load} that may not be provided by the source current Iₛ generated by the current source 104. Accordingly, the LDO current I_{LDO} may provide frequency components of the load current I_{Load} that may not be provided by the source current Iₛ. For example, if the source current Iₛ provides frequency components of the load current I_{Load} that are 5 hertz or less, the LDO current I_{LDO} may provide all frequency components of the load current I_{Load} that are higher than 5 hertz as well as frequency components of the load current I_{Load} that are 5 hertz or less that may not be supplied by the source current Iₛ. In some embodiments, some of the higher frequency components may have a frequency at least an order of magnitude greater than the low frequency components. For example, the low frequency components may have a frequency range approximately between 0 Hz (Direct Current) and 5 Hz and the higher frequency components may have a frequency range approximately between 5 Hz all the up to 50 gigahertz (GHz).

As detailed below, with the current source 104 providing at least a portion of the load current I_{Load} with the source current Iₛ, a power transistor of the regulator 102 that may source the LDO current I_{LDO} may be smaller than if the current source 104 were not included in the circuit 100 because the LDO current I_{LDO} may be less than if the current source 104 were not present. Therefore, the regulator 102 may have a smaller footprint on a silicon die as compared to other LDO voltage regulators. In particular, the power transistor of the regulator 102 may be smaller because the regulator 102 may source the higher frequency portions of the load current I_{Load} that are typically smaller than the DC or low frequency components of the load current I_{Load}. Because the higher frequency portions of the load current I_{Load} are typically smaller, the power transistor of the regulator 102 may be reduced in size. Furthermore, because the regulator 102 provides the higher frequency portions of the load current I_{Load}, the circuit 100 may still respond to changes in energy draw by the load circuit 108 to maintain the voltage V_{DD} at the supply node 106 at a substantially consistent, or consistent, voltage as may be used by the load circuit 108. Furthermore, by reducing the size of the power transistor of the regulator 102, the circuit 100 may be able to respond more quickly to the changes in energy draw by the load circuit 108 than if the power transistor of the regulator 102 was sized to provide all of the load current I_{Load}.

The circuit 100 may also include a capacitor 110. The capacitor 110 may be coupled between the supply node 106 and a ground of the circuit 100. The capacitor 110 may be a compensation capacitor configured to stabilize the regulator 102. A size of the capacitor 110 may be at least partially related to a size of the power transistor of the regulator 102 that may source the LDO current I_{LDO}. For example, typically the bigger the power transistor, the bigger the size requirement of the capacitor 110 to stabilize the regulator 102. As mentioned above, a size requirement of the power transistor of the regulator 102 may be reduced with the inclusion of the current source 104. Therefore, the current source 104 may also reduce the size requirement and size of the capacitor 110.

In some embodiments, the size of the capacitor 110 may be reduced such that the capacitor 110 may be included on the same encapsulated silicon die as the regulator 102. Additionally, as mentioned above, the regulator 102 and the current source 104 may also be on the same encapsulated silicon die such that the regulator 102, the current source 104, and the capacitor 110 may be included on the same encapsulated silicon die. In these or other embodiments, the load circuit 108 may also be included on the same encapsulated silicon die as the regulator 102, the current source 104, and the capacitor 110, such as illustrated with respect to the encapsulated silicon die 101 of FIG. 1. Having one or more of the listed components included on the same encapsulated silicon die may reduce an overall foot print of the circuit 100 on the encapsulated silicon die as well as reducing a pinout of the encapsulated silicon die, which may save space.

Modifications, additions, or omissions may be made to the circuit 100 without departing from the scope of the present disclosure. For example, the circuit 100 may include any number of other components not specifically illustrated or described herein.

FIG. 2 illustrates an example voltage regulation circuit 200 (“the circuit 200”), arranged in accordance with at least one embodiment described herein. The circuit 200 may be analogous to the circuit 100 of FIG. 1 and may include an LDO voltage regulator 202 (referred to hereinafter as “the LDO 202”), a current source 204, a load circuit 208, and a capacitor 210. The LDO 202, the current source 204, the load circuit 208, and the capacitor 210 may be analogous to the regulator 102, the current source 104, the load circuit 108, and the capacitor 110, of FIG. 1. In the illustrated embodiment, the LDO 202, the current source 204, the load circuit 208, and the capacitor 210 are depicted as being included on an encapsulated silicon die 201, as an example.

As such, the load circuit 208 may be coupled to a supply node 206 of the circuit 200 such that the load circuit 208 receives its power from the supply node 206, which may have a supply voltage V_{DD} generated by the LDO 202. Additionally, the load circuit 208 may draw a load current I_{Load} from the supply node 206. Similar to the current source 104, the current source 204 may be configured to generate a low frequency (e.g., a DC current or a current less than 10 Hz) source current Iₛ that may be supplied to the load circuit 208 via the supply node 206. Therefore, the source current Iₛ may provide at least a portion of the load current I_{Load} to the load circuit 208. In the illustrated embodiment, the current source 204 may be configured to source the source current Iₛ from a supply voltage V_{DD2}.

The LDO 202 may include a power transistor 216, a feedback 214 and an operational-amplifier (op-amp) 212. The power transistor 216 may be any suitable transistor, and in the illustrated embodiment may be a p-channel metal-oxide-semiconductor field effect transistor (PMOS transistor). The power transistor 216 may have a source coupled to a supply voltage V_{DD1} and may have a drain coupled to the supply node 206. In some embodiments, the supply voltage V_{DD1} may be the same as the supply voltage V_{DD2} and in other embodiments, the supply voltage V_{DD1} may be different from the supply voltage V_{DD2}. A gate of the power transistor 216 may be coupled to an output port 215 of the op-amp 212 such that the power transistor 216 may be driven by the op-amp 212.

As explained below, the op-amp 212 may drive the power transistor 216 such that the supply voltage V_{DD} at the supply node 206 is based on a reference voltage V_{Ref} and such that the power transistor 216 sources an LDO current I_{LDO} from the supply voltage V_{DD1}. Similar to as described above with respect to FIG. 1, the LDO current I_{LDO} may provide the low frequency components of the load current I_{Load} that may not be provided by the source current Iₛ (if there are any) as well as the higher frequency components of the load current I_{Load}.

The amount of current that the power transistor 216 is able to source, such as the LDO current I_{LDO}, may be based on the size of the power transistor 216, where the bigger the size, the more LDO current I_{LDO} the power transistor 216 may be able to source. Accordingly, as explained above with respect to FIG. 1, because the current source 204 may provide at least a portion of the load current I_{Load} instead of the power transistor 216 providing all of the load current I_{Load}, as in traditional implementations, the power transistor 216 may be smaller than if the current source 204 were omitted.

In some embodiments, the feedback 214 may include any suitable passive and/or active electrical component that may be coupled between the supply node 206 and a positive input port 211 of the op-amp 212. In other embodiments, the feedback 214 may merely be a coupling of the positive input port 211 with the supply node 206 without any intermediate components between them. The feedback 214 may be configured such that a relationship may exist between the supply voltage V_{DD} at the supply node 206 and a voltage at the positive input port 211. In some embodiments, the relationship may be a gain that may be greater than, less than, or equal to one.

For example, in some embodiments, the feedback 214 may include a voltage divider that may apply a gain between the supply voltage V_{DD} at the supply node 206 and the voltage at the positive input port 211. An example configuration of a feedback that includes a voltage divider is illustrated and described below with respect to FIG. 3. As another example, when the feedback 214 is merely a coupling between the positive input port 211 and the supply node 206, the relationship between the supply voltage V_{DD} and the voltage at the positive input port 211 may be approximately equal to a gain of one such that the supply voltage V_{DD} may be approximately equal to the voltage at the positive input port 211.

The op-amp 212 that may also include a negative input port 213 that may be configured to receive the reference voltage V_{Ref}. The configuration of the op-amp 212, the power transistor 216, and the feedback 214 may be such that the op-amp 212 may generate an output voltage at the output port 215 that drives the power transistor 216 in a manner that generates a voltage at the supply node 206 (e.g., the supply voltage V_{DD}) that results in a voltage at the positive input port 211 that substantially equals the reference voltage V_{Ref}. For example, when the gain of the feedback 214 is 0.5 and the reference voltage V_{Ref} is 2.5 volts, the op-amp 212 may drive the power transistor 216 such that the supply voltage V_{DD} is approximately equal to 5 volts, which may result in the voltage at the positive input port 211 being approximately equal to the 2.5 volts of the reference voltage V_{Ref}.

The capacitor 210 may be analogous to the capacitor 110 of FIG. 1 and may be coupled between the supply node 206 and a ground of the circuit 200. Similar to the reasons discussed above with respect to the size of the capacitor 110, a size of the capacitor 210 may be based on the size of the power transistor 216. As mentioned above, the size requirement of the power transistor 216 may be reduced with the inclusion of the current source 204 such that the size requirement and size of the capacitor 210 may also be reduced. In some embodiments, the size of the capacitor 210 may be reduced such that the capacitor 210 may be included on same encapsulated silicon die as the LDO 202, such as illustrated with respect to the encapsulated silicon die 201 of FIG. 2.

Modifications, additions, or omissions may be made to the circuit 200 without departing from the scope of the present disclosure. For example, the circuit 200 may include any number of other components not specifically illustrated or described herein. Further, the illustration of the LDO 202 is merely an example implementation of an LDO voltage regulator and is not a limiting example.

FIG. 3 illustrates an example voltage regulation circuit 300 (“the circuit 300”), arranged in accordance with at least one embodiment described herein. The circuit 300 may include an LDO voltage regulator 302 (referred to hereinafter as “the LDO 302”), a current source 304, a load circuit 308, and a capacitor 310. The LDO 302 may be analogous to the regulator 102 of FIG. 1. The current source 304, the load circuit 308, and the capacitor 310 may be analogous to the current sources 104 and 204, the load circuits 108 and 208, and the capacitors 110 and 210, of FIGS. 1 and 2. In the illustrated embodiment, the LDO 302, the current source 304, the load circuit 308, and the capacitor 310 are depicted as being included on an encapsulated silicon die 301, as an example.

Accordingly, the load circuit 308 may be configured to receive its power from a supply node 306, which may have a supply voltage V_{DD} generated by the LDO 302. Additionally, the load circuit 308 may draw a load current I_{Load} from the supply node 306. Similar to the current sources 104 and 204, the current source 304 may be configured to generate a low frequency (e.g., a DC current or a current less than 10 Hz) source current Iₛ that may be supplied to the load circuit 308 via the supply node 306. In the illustrated embodiment, the current source 204 may be configured to source the source current Iₛ from a supply voltage V_{DD2}.

The LDO 302 may also be similar to the LDO 202 in that the LDO 302 may include an op-amp 312 and a power transistor 316 analogous to the op-amp 212 and the power transistor 216, respectively, of FIG. 2. Additionally, the LDO 302 may include a feedback 314 that may be an example implementation of the feedback 214 of FIG. 2. The feedback 314 in the illustrated embodiment may be a voltage divider coupled between the supply node 306 and a positive input node 311 of the op-amp 312. The voltage divider may include a first resistor 318a and a second resistor 318b configured in the manner illustrated in FIG. 3.

The LDO 302 may also include a source follower 320 coupled between an output port 315 of the op-amp 312 and a gate of the power transistor 316. The source follower 320 may include a transistor 322 and a current source 324. The transistor 322 may be an n-channel metal-oxide-semiconductor field effect transistor (NMOS transistor) that may have a drain coupled to a supply voltage V_{DD3}. In some embodiments, the supply voltage V_{DD3} may be the same as the supply voltage V_{DD2} associated with the current source 304, and in other embodiments, the supply voltage V_{DD3} and the supply voltage V_{DD2} may be different. A gate of the transistor 322 may be coupled to the output port 315 and a source of the transistor 322 may be coupled to a gate of the power transistor 316 such that a source voltage of the transistor 322 may drive the power transistor 316.

The source follower 320 may be configured such that the source voltage of the transistor 322 may follow (e.g., be approximately equal to) the voltage at its gate. Therefore, because the gate of the transistor 322 is coupled to the output port 315 and the source of the transistor 322 is coupled to the gate of the power transistor 316, the voltage driving the power transistor 316 may be approximately equal to the voltage at the output port 315. Accordingly, the op-amp 312 may drive the power transistor 316 based off of a reference voltage V_{Ref} received at a negative input port 313 in a manner that produces the supply voltage V_{DD} at the supply node 306 and such that the power transistor 316 sources an LDO current I_{LDO} as part of the load current I_{Load} in an analogous manner as that described above with respect to FIG. 2. The power transistor 316 may source the current from a supply voltage V_{DD1}, which may be the same as or different than the supply voltage V_{DD3} and/or the supply voltage V_{DD2}. For reasons described above with respect to the power transistor 216, the power transistor 316 may have a relaxed size requirement due to the inclusion of the current source 304. Additionally, for reasons described above, a size requirement of the capacitor 310 may be reduced at least in part due to the reduced size requirement of the power transistor 316.

The inclusion of the source follower 320 may increase the bandwidth of the LDO 302 as compared to the LDO 302 not including the source follower 320. For example, the transistor 322 may be significantly smaller than (e.g., 1/10^{th} the size of) the power transistor 316 even with the relaxed size requirements of the power transistor 316. The reduced size of the transistor 322 as compared to the power transistor 316 may reduce the capacitance seen by the op-amp 312 at the output port 315 of the op-amp 312. The reduced capacitance at the output port 315 may allow for the op-amp 312 to change the voltage at the output port 315 faster than if the output port 315 were coupled to the gate of the power transistor 316 without the source follower 320 coupled there between. As such, the op-amp 312 may have a better frequency response over a higher frequency range with the inclusion of the source follower 320. Therefore, the source follower 320 may increase the bandwidth of the LDO 302.

Modifications, additions, or omissions may be made to the circuit 300 without departing from the scope of the present disclosure. For example, the circuit 300 may include any number of other components not specifically illustrated or described herein. Further, the illustration of the LDO 302 is merely an example implementation of an LDO voltage regulator and is not a limiting example.

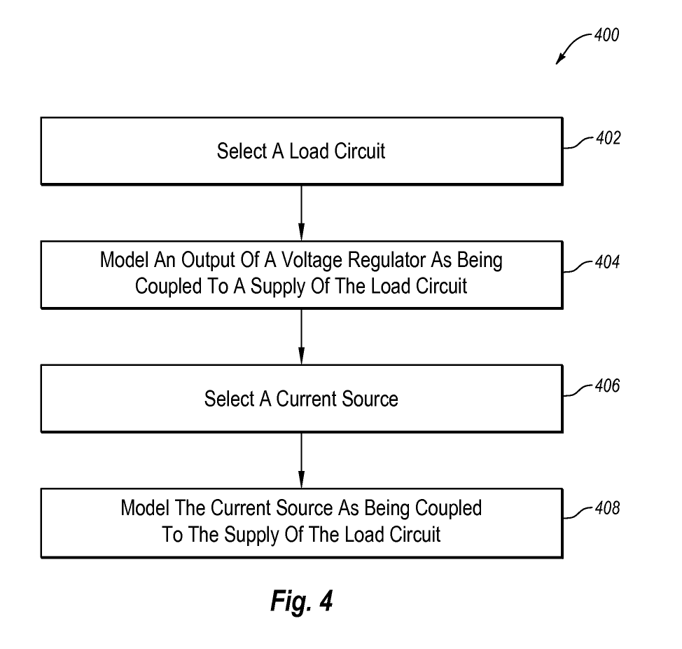

FIG. 4 is a flowchart of an example method 400 of designing a circuit to have a compact LDO voltage regulator, arranged in accordance with at least one embodiment described herein. The method 400 may be implemented, in some embodiments, using any applicable design software stored on a computer-readable storage medium according to the principles described above with respect to the circuits 100, 200, and 300 of FIGS. 1-3 respectively. Although illustrated as discrete blocks, various blocks may be divided into additional blocks, combined into fewer blocks, or eliminated, depending on the desired implementation.

The method 400 may begin at block 402, where a load circuit may be selected. At block 404 an output of a low-dropout (LDO) voltage regulator may be modeled as being coupled to a supply of the load circuit and as providing a supply voltage to the load circuit. At block 406, a current source may be selected.

At block 408, the current source may be modeled as being coupled to the supply of the load circuit and the output of the LDO voltage regulator. The modeling of the current source in this manner may be such that the current source is modeled as supplying current to the load circuit in a manner that reduces current supplied to the load circuit by the LDO voltage regulator. In some embodiments, the current source and the LDO voltage regulator may be modeled such that the current supplied to the load circuit by the current source has a first frequency that is lower than a second frequency of at least a portion of the current supplied to the load circuit by the LDO voltage regulator. In these or other embodiments, the first frequency may be lower than the second frequency by at least an order of magnitude. For example, the first frequency may be less than one Hz such that the current supplied by the current source is essentially a DC current and the second frequency may be greater than 10 Hz.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the method 400 may further include selecting a capacitor configured to stabilize the LDO voltage regulator. A size of the capacitor may be selected based on a reduced size requirement due to the current source supplying current to the load circuit. Similarly, the method 400 may include selecting, for the LDO voltage regulator, a power transistor configured to supply current to the load circuit. A size of the power transistor may be selected based on a reduced size requirement due to the current source also supplying current to the load circuit. Additionally, in some embodiments, the method 400 may include steps associated with modeling one or more of the LDO voltage regulator, the current source, the capacitor, and the load circuit as being included on the same encapsulated silicon die.

The method 400 described herein may be implemented using any suitable special-purpose or general-purpose computer, computing entity, or processing device including various computer hardware or software modules and may be configured to execute computer-executable instructions stored on any applicable computer-readable media. For example, the method 400 may be performed by a processor that may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Computer-readable media may be any available media that may be accessed by a general-purpose or special-purpose computer (e.g., a processor). By way of example, and not limitation, such computer-readable media may include a non-transitory or tangible computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, or any other storage medium which may be used to carry or store desired program code in the form of computer-executable instructions or data structures and which may be accessed by a general-purpose or special-purpose computer. Combinations of the above may also be included within the scope of computer-readable media. The computer-readable media may include computer-executable instructions which may include, for example, instructions and data that cause a general-purpose computer, special-purpose computer, or special-purpose processing device to perform a certain function or group of functions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

All examples and conditional language recited herein are intended as pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A circuit comprising:
a low-dropout (LDO) voltage regulator including an output coupled to a supply of a load circuit, the LDO voltage regulator being configured to provide a supply voltage to the load circuit; and
a current source coupled to the supply of the load circuit and the output of the LDO voltage regulator, the current source being configured to supply current to the load circuit in a manner that reduces current supplied to the load circuit by the LDO voltage regulator.

2. The circuit of claim 1, further comprising an encapsulated silicon die that includes the LDO voltage regulator, the current source, and the load circuit.

3. The circuit of claim 2, wherein the encapsulated silicon die includes a capacitor configured to stabilize the LDO voltage regulator.

4. The circuit of claim 1, wherein the LDO voltage regulator includes a power transistor configured to supply current to the load circuit, the power transistor having a size based on a reduced size requirement due to the current source also supplying current to the load circuit.

5. The circuit of claim 1, wherein the current supplied to the load circuit by the current source has a first frequency lower than a second frequency of at least a portion of the current supplied to the load circuit by the LDO voltage regulator.

6. The circuit of claim 5, wherein the first frequency is lower than the second frequency by at least an order of magnitude.

7. The circuit of claim 1, further comprising a capacitor configured to stabilize the LDO voltage regulator, the capacitor having a size based on a reduced size requirement due to the current source supplying current to the load circuit.

8. The circuit of claim 1, wherein the current supplied to the load circuit by the current source is a low-frequency current.

9. The circuit of claim 8, wherein the low-frequency current is less than 10 Hertz (Hz).

10. A method of designing a circuit, the method comprising:
selecting a load circuit;
modeling an output of a low-dropout (LDO) voltage regulator as being coupled to a supply of the load circuit and as providing a supply voltage to the load circuit;
selecting a current source; and
modeling the current source as being coupled to the supply of the load circuit and the output of the LDO voltage regulator such that the current source is modeled as supplying current to the load circuit in a manner that reduces current supplied to the load circuit by the LDO voltage regulator.

11. The method of claim 10, further comprising modeling the LDO voltage regulator, the current source, and the load circuit as being included within an encapsulated silicon die.

12. The method of claim 11, further comprising:
selecting a capacitor configured to stabilize the LDO voltage regulator; and
modeling the encapsulated silicon die as including the capacitor.

13. The method of claim 10, further comprising selecting, for the LDO voltage regulator, a power transistor configured to supply current to the load circuit, a size of the power transistor being selected based on a reduced size requirement due to the current source also supplying current to the load circuit.

14. The method of claim 10, wherein the current source and LDO voltage regulator are modeled such that the current supplied to the load circuit by the current source has a first frequency lower than a second frequency of at least a portion of the current supplied to the load circuit by the LDO voltage regulator.

15. The method of claim 14, wherein the first frequency is lower than the second frequency by at least an order of magnitude.

16. The method of claim 10, further comprising selecting a capacitor configured to stabilize the LDO voltage regulator, a size of the capacitor being selected based on a reduced size requirement due to the current source supplying current to the load circuit.

17. An encapsulated silicon die comprising:
a load circuit;
a low-dropout (LDO) voltage regulator including an output coupled to a supply of the load circuit, the LDO voltage regulator being configured to provide a supply voltage to the load circuit; and
a current source coupled to the supply of the load circuit and the output of the LDO voltage regulator, the current source being configured to supply current to the load circuit in a manner that reduces current supplied to the load circuit by the LDO voltage regulator.

18. The encapsulated silicon die of claim 17, wherein the LDO voltage regulator includes a power transistor configured to supply current to the load circuit, the power transistor having a size based on a reduced size requirement due to the current source also supplying current to the load circuit.

19. The encapsulated silicon die of claim 17, further comprising a capacitor configured to stabilize the LDO voltage regulator, the capacitor having a size based on a reduced size requirement due to the current source supplying current to the load circuit.

20. The encapsulated silicon die of claim 17, wherein the current supplied to the load circuit by the current source has a first frequency that is lower than a second frequency of at least a portion of the current supplied to the load circuit by the LDO voltage regulator.
